(19) United States
(12) Patent Application Publication
(10) Pub. No.: US 2016/0127731 A1
(43) Pub. Date: May 5, 2016

(54) MACROBLOCK SKIP MODE JUDGEMENT METHOD FOR ENCODER

(71) Applicant: National Chung Cheng University, Min-Hsiung (TW)

(72) Inventors: Jiun-In GUO, Minsyong Township, Chiayi County (TW); Jin-Ming CHEN, HsinChu (TW); Hsiu-Cheng CHANG, Hsinchu (TW); Cheng-An CHIEN, Min-Hsiung Chia-Yi (TW)

(21) Appl. No.: 14/531,322

(22) Filed: Nov. 3, 2014

(51) Int. Cl. H04N 19/137; H04N 19/523; H04N 19/176; H04N 19/52; H04N 19/105; H04N 19/13

(52) U.S. Cl. CPC H04N 19/137; H04N 19/105; H04N 19/13; H04N 19/176; H04N 19/52; H04N 19/523

(57) ABSTRACT

A macroblock skip mode judgement method for an encoder applies to implementation of H.264 encoder hardware compressing a plurality of successive frames and comprises steps: undertaking IME (Integer Motion Estimation) for two frames appearing at neighboring time points to calculate MV (Motion Vector), and calculating PMV (Predicted Motion Vector) of the frame appearing the preceding time point; if MV equals PMV, modifying the cost function of MV to be a negative value; undertaking block encoding and compare the costs; if the cost of the Inter mode is smaller than the cost of the Intra mode, setting the mb (macroblock) skip flag to be 1; using Entropy to compress the mb skip flag, and omitting compressing the macroblock represented by the mb skip flag.

### BACKGROUND OF THE INVENTION

1. Field of the Invention

The present invention relates to a video encoding technology, particularly to a macroblock skip mode judgement method suitable for the implementation of the H.264 encoder hardware.

2. Description of the Related Art

In 2003, ITU-T (Telecommunication Standardization Sector of the International Telecommunications Union) proposed a compression standard H.264 for high-quality images. In comparison with the conventional MPEG-2 and MPEG-4, H.264 can increase compression rate more effectively. Although H.264 continues using the conventional encoding process, it applies several new technologies to processing blocks and improving compression rate, including multiple reference frames, variable block size, quarter-pixel motion compensation, intra frame prediction using the spatial similarities between neighbor blocks, context-based adaptive variable length coding, and adaptive arithmetic coding, which were never used in the conventional video compression standards.

In intra-frame encoding prediction, H.264 provides 4 prediction modes for each 16×16 luma block, 9 prediction modes for each 4×4 luma block, and 4 prediction modes for each 8×8 chrominance block. Thus, [4 (for 16×16)+9×16 (for 4×4)] modes need calculating to achieve the optimized mode for a 16×16 chrominance block. Therefore, each optimized mode is at the cost of lengthy computation. An image is normally divided into a plurality of macroblocks (MB), and the encoding mode is predicted macroblockwise (macroblock by macroblock). In practice, a lot of time is spent in computation for encoding each MB.

While successive images from a given lens are compressed, the backgrounds of the preceding image and the following image are normally unchanged. Therefore, the images of many MBs are identical or similar. In the original H.264 standard, the following steps must be employed before compressing data in an MB skip mode: undertaking all ME (Motion Estimation) calculations; undertaking an extra cost-estimation calculation for an MB skip mode; involving the cost of the MB skip mode in the following cost comparison process; compressing data in the MB skip mode if the MB mode is the optimized mode in comparison. Therefore, if an MB skip mode compression is required in the implementation of the H.264 encoder hardware, the cost of an MB skip mode must be estimated and involved in the following cost comparison process, which not only consumes additional computation time but also lowers the performance of the hardware intended to accelerate processing video data.

Accordingly, the present invention proposes a macroblock skip mode judgement method for an encoder to overcome the abovementioned problems.

### SUMMARY OF THE INVENTION

The primary objective of the present invention is to provide a macroblock skip mode judgement method for an encoder, which uses a macroblock skip mode of the H.264 standard to compress data, wherein only a piece of image among successive images from a given lens is compressed, and wherein the data of some macroblocks of several following images needn't be compressed but duplicated from the former macroblocks, whereby data volume is greatly reduced and compression rate is obviously promoted.

Another objective of the present invention is to provide a macroblock skip mode judgement method for an encoder, wherein while the motion vector is equal to the predicted motion vector, a new cost function for a macroblock skip mode compatible with the original cost function is used to estimate the cost of a macroblock skip mode, and the estimated cost is involved in the following cost comparison process to find out the optimized compression mode.

A further objective of the present invention is to provide a macroblock skip mode judgement method for an encoder, which works out the smallest bit stream and maintains a good quality of video encoding without increasing computational burden in cost comparison.

To achieve the abovementioned objectives, the present invention proposes a macroblock skip mode judgement method for an encoder, which applies to the implementation of the H.264 encoder hardware for compressing successive images, and which comprises two stages: firstly undertaking IME (Integer Motion Estimation) for two images appearing at neighboring time points to calculate MV (Motion Vector) and PMV (Predicted Motion Vector); if MV equals PMV, modifying the cost function of MV to be a negative value; next encoding the blocks according to H.264, and comparing the costs thereof; while the intra-mod cost is smaller than the inter-mode cost, setting the MB skip flag to be 1; omitting the compression of MB itself but using entropy to compress the MB skip flag to form an MB skip mode bit stream. Thereby, the present invention greatly reduces the volume of encoded video data and maintains a good quality of video encoding.

### BRIEF DESCRIPTION OF THE DRAWINGS

FIG. 1 shows a flowchart of a macroblock skip mode judgement method for an encoder according to one embodiment of the present invention; and

FIG. 2 shows curves of the compression rates of the present invention and other methods.

### DETAILED DESCRIPTION OF THE INVENTION

The present invention discloses a macroblock (MB) skip mode judgement method, which enables the H.264 encoder hardware to compress video data into an MB skip mode bit stream having a higher compression rate and a smaller file volume than the conventional H.264 compression method can achieve, and which is more suitable for the implementation of the H.264 encoder hardware than the conventional judgement method provided by the H.264 standard. Thereby, the present invention can compress video data efficiently in realtime and maintain a good quality of video encoding.

While successive images captured by a given lens are compressed, the backgrounds of the preceding frame and the following frames are normally unchanged. Therefore, the images of many macroblocks of the preceding frame and the following frames are identical or similar. Thus, the H.264 standard provides an MB skip mode, which only compresses the preceding frame, and which does not compress the identical MBs of the following frames repeatedly but duplicates the MBs of the preceding frame for the following identical MBs, whereby to greatly reduce data volume and effectively promote video compression rate.

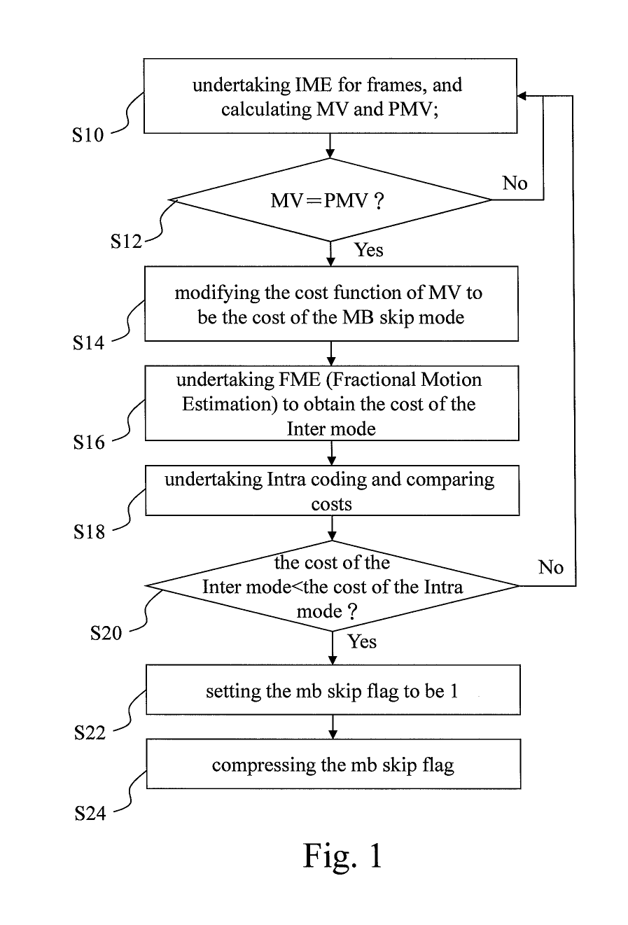

An image contains a plurality of macroblocks. Each macroblock involves the aspects of IME (Integer Motion Estimation), FME (Fractional Motion Estimation), intra coding and entropy. Refer to FIG. 1 for a flowchart of a macroblock skip mode judgement method for an encoder according to one embodiment of the present invention. In Step S10, undertake IME of two frames appearing at neighboring time points to obtain the motion vectors (MV) thereof, and use a full-search method to predict the motion vector of the frame appearing at the preceding time point, i.e. to obtain the predicted motion vector (PMV). If the current frame is Fₙ, PMV is the vector of Frame Fₙ₋₁. In Step S12, examine whether PMV equals MV. If PMV does not equal MV, the process returns to Step S10, and select other two frames for Step S10. If PMV equals MV, the process proceeds to Step S14. In Step S14, modify the cost function of MV to be a negative value. The cost function of MV of a 16×16 block is modified to be a negative value according to Equation (1):

Cost=−(8*λ+0.4999) (1)

wherein λ is a Lagrange multiplier the H.264 standard uses to calculate the cost function of the MB skip mode.

In Step S16, undertake FME to obtain the cost of an Inter mode. In Step S18, encode blocks and compare the costs. In Step S20, examine whether the cost of the Inter mode is smaller than the cost of the Intra mode. If the cost of the Inter mode is smaller than the cost of the Intra mode, the process proceeds to Step S22. In Step S22, the MB skip flag is set to be 1 as shown in Equation (2):

mb_skip_flag=1 (2)

In Step S22, the MB skip flag will not be set to be 1 unless three conditions are satisfied: CBP (Coded Block Type) is 0; the Inter mode of the 16×16 blocks is confirmed after cost comparison; and the cost of the MB skip mode is expressed by Equation (1).

If the cost of the Inter mode is not smaller than the cost of the Intra mode, the process returns to Step S10, and select other two frames for Step S10. In Step S24, omit compressing the macroblock itself and use Entropy to compress the MB skip flag that represents the macroblock, whereby the video data is still compressed into an MB skip mode bit stream.

From the above description, it is known: the method of the present invention includes two stages; Steps S10-S14 belong to the first stage, and Steps S18-S22 belong to the second stage. In the first stage, while MV equals PMV, the cost of MV is compulsorily modified to be the cost of the MB skip mode, which is to replace the computation originally undertaken in the H.264 standard to calculate the cost of the MB skip mode. The original H.264 standard involves the cost of the MB skip mode in the following cost comparison process. The present invention has simplified the calculation of the cost of the MB skip mode in the first stage. Therefore, the present invention can exempt the following cost comparison process from the calculation originally undertaken in the H.264 standard to compare the cost of the MB skip mode with the costs of other modes. Therefore, the present invention can save the hardware a lot of time in undertaking the cost comparison process.

The MB skip mode is one of the original designs of the H.264 standard. The MB skip mode is an MB partition mode of the of the Inter mode. After a macroblock is transformed and quantified, whether the residuals are zero is examined to determine the coded block pattern (CBP) thereof. If the residuals are all zero, the macroblock is designated a not coded block. If the residuals are not all zero, the macroblock is designated a coded block. A coded block is partitioned into four 8×8 luma blocks or two 8×8 chrominance blocks. In Step S22, the residuals should be all zero, i.e. the macroblock is a not coded block. In such a case, the present invention does not compress the macroblocks of several following images but compresses the former macroblock in the MB skip mode, wherein the MB skip flag that representing the macroblock is compressed.

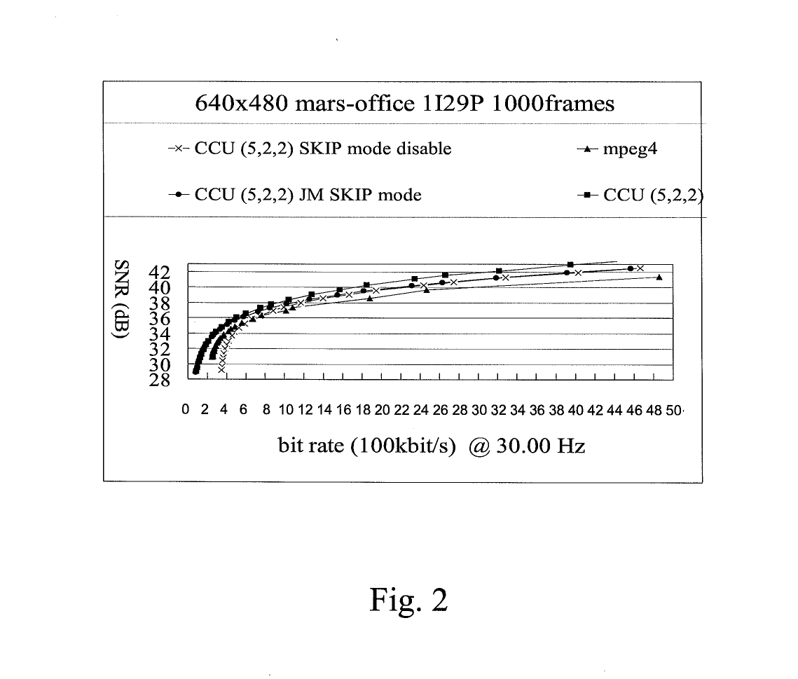

Refer to FIG. 2 showing curves of the compression performances of the present invention and other methods, wherein □ denotes the performance of the compression using the present invention; x denotes the performance of the compression without using the present invention; ◯ denotes the performance of the compression using the reference software JM of the original H.264 standard. The compression rate of the compression using the present invention is 60% higher than that without using the present invention, approaching that using the reference software JM of the original H.264 standard. It proves: the present invention can effectively increase the compression rate and maintain a good quality of video encoding. The present invention can further decrease the complexity in designing the H.264 encoder hardware. Compared with the former generation video compression standard MPEG4, the macroblock skip mode judgement method of the present invention can achieve a better compression quality, i.e. a higher signal-to-noise ratio, even in the range of high compression rate. Further, the macroblock skip mode judgement method of the present invention has a higher compression rate than MPEG4 while the quality (signal-to-noise ratio) is the same.

In conclusion, the present invention proposes a macroblock skip mode judgement method for an encoder, which establishes a new way to calculate the cost of the MB skip mode, whereby the cost will not be calculated in the ME (Motion Estimation) stage. While MV equals PMV, the cost of MV is modified to be the cost of the MB skip mode compulsorily. The costs of various encoding modes of the H.264 standard are compared, including the cost of the MB skip mode. While the MB skip mode has the least cost, video data is compressed in the MB skip mode. The method of the present invention can find out the encoding mode having the least encoding cost without increasing encoding cost and obtain an MB skip mode video bit stream. The method of the present invention can increase the compression rate by 60%. Further, the method of the present invention is suitable for the implementation of the H.264 encoder hardware. Therefore, the method of the present invention can compress video data into high quality and low volume H.266 video bit streams in realtime.

The embodiments described above are only to exemplify the present invention but not to limit the scope of the present invention. Any equivalent modification or variation according to the characteristic or spirit of the present invention is to be also included with the scope of the present invention.

What is claimed is:

1. A macroblock skip mode judgement method for an encoder, which applies to implementation of H.264 encoder hardware compressing a plurality of successive frames, comprising steps:
undertaking IME (Integer Motion Estimation) for two frames appearing at neighboring time points to calculate at least one MV (Motion Vector), and calculating a PMV (Predicted Motion Vector) of said frame appearing at a preceding said time point;
if said MV equals said PMV, modifying a cost function of said MV to be a negative value; if said MV does not equal said PMV, returning to the former step and undertaking IME for other two frames of said successive frames;
undertaking Intra coding and comparing costs; if a cost of an Inter mode is smaller than a cost of an Intra mode, setting an mb (macroblock) skip flag to be 1; and
using Entropy to compress said mb skip flag, and omitting compressing said macroblock represented by said mb skip flag.

2. The macroblock skip mode judgement method for an encoder according to claim 1, wherein each said frame contains a plurality of macroblocks.

3. The macroblock skip mode judgement method for an encoder according to claim 1, wherein said MV that equals said PMV is a motion vector of a 16×16 block.

4. The macroblock skip mode judgement method for an encoder according to claim 1, wherein said PMV is calculated with a full-search method.

5. The macroblock skip mode judgement method for an encoder according to claim 1, wherein a cost of said macroblock skip mode is calculated according to cost=−(8*λ+0.4999), and wherein λ is a Lagrange multiplier.

6. The macroblock skip mode judgement method for an encoder according to claim 1, wherein said negative value is a cost of said macroblock skip mode if following conditions are satisfied: said cost of said Inter mode is smaller than said cost of said Intra mode; CBP (Coded Block Pattern) is 0; said Inter mode of a 16×16 block is confirmed.

7. The macroblock skip mode judgement method for an encoder according to claim 1, wherein said mb skip flag=1.

8. The macroblock skip mode judgement method for an encoder according to claim 1, wherein before undertaking said Intra coding, FME (Fractional Motion Estimation) is undertaken to obtain said cost of said Inter mode.
